(19) United States
(12) Patent Application Publication
(10) Pub. No.: US 2017/0166235 A1
(43) Pub. Date: Jun. 15, 2017

(54) (ISD) VEHICLE SAFETY

(71) Applicant: Jermaine Walker, Las Vegas, NV (US)

(72) Inventor: Jermaine Walker, Las Vegas, NV (US)

(21) Appl. No.: 14/965,892

(22) Filed: Dec. 10, 2015

(51) Int. Cl. B62D 1/04; H04M 1/725; H04W 4/00; B60K 28/06

(52) U.S. Cl. CPC B62D 1/046; B60K 28/06; H04M 1/72577; H04W 4/008; B60Y 2302/07; B60Y 2302/03

(57) ABSTRACT

This design includes a steering wheel and app working together to operate properly. It uses interruption feature in wheel preventing texting, facetime, social sites, and social media up to two feet away from steering wheel. It will disarm feature when vehicle is placed in park. Inside steering wheel is an alcohol level detector and heart rate sensor. If over legal limit design will broadcast event in app. This causes steering wheel to lock. Design will then call and text contacts in app on behalf of driver. A gel pressure sensor under leather cover of steering wheel will detect pressure. If there is not enough pressure on steering wheel to safely operate it. Design alerts driver sending sound through speakers in steering wheel and flashes lights located on steering wheel. Design then calls and text contacts in app. Erratic speeds will cause design to call and text contacts in app.

### BACKGROUND

Each year in the United States there are thousands of vehicle fatalities. To go along with that number there are over one million injuries that occur from vehicle accidents. Per United States Department of Transportation.

### BRIEF SUMMARY

This invention is designed to prohibit drunk driving. It is also designed to eliminate distracted drivers. Due to careless driving. Even more to target the drivers that participate in the use of texting, face time, social sites, and social media while operating a vehicle. And the observation of vehicle speed if another area of concern this invention will address.

### DETAILED DESCRIPTION

Drunk Driving—If someone has been drinking and over the legal limit the steering wheel will lock. Working in conjunction is the steering wheel and app. At this point the steering device will call and text the contacts that have been loaded into the app on the behalf of the driver. The contact numbers loaded into this app should be people with the best interest of the driver. There will be an alcohol detector and heart rate sensor built into the steering wheel. It will be located in the center of the steering wheel ring which you hold to drive. To make this work we will take the steering wheel ring cut it into two pieces. Once separated the alcohol detector/heart rate sensor ring is placed between the two parts of the steering wheel. Then four bolts are placed in the back of the steering wheel to attach all three parts.

Distracted Driver—If someone is driving and try to use texting, face time, social sites, and social media the steering device will not allow it. Until the vehicle gear is placed in park is when they can use those features. This is done by the interruption feature which will be located behind the airbag on an electronic board.

Distracted Driver—If someone is operating a vehicle and there is not enough pressure on the steering wheel it will alert the driver. Sending sound through the speakers in the steering wheel and flashing lights located on the steering wheel. The steering device will then call and text someone on the drivers behalf. This part of the device is made with speakers that are placed on each side of the airbag behind the port covers. Two alert lights will be placed on top of the port covers. The other light will be placed on the frame of the steering wheel under the airbag. The connections for the speakers and lights will be made on the electronic board behind the airbag.

Speed—If the vehicle is operating with erratic speeds this will cause the steering device to call and text someone on the driver's behalf. For this to be made will lie in conjunction through the steering wheel on an electronic board chip and app that both understand speed.

There is a built in tracking device that's located on an electronic board behind the airbag. Through the app the vehicle can be tracked. Bluetooth is also built in on the electronic board. This connects the steering wheel and app.

### BRIEF DESCRIPTION OF THE SEVERAL VIEWS OF THE DRAWING

FIG. 1 This is a front view of the steering wheel.

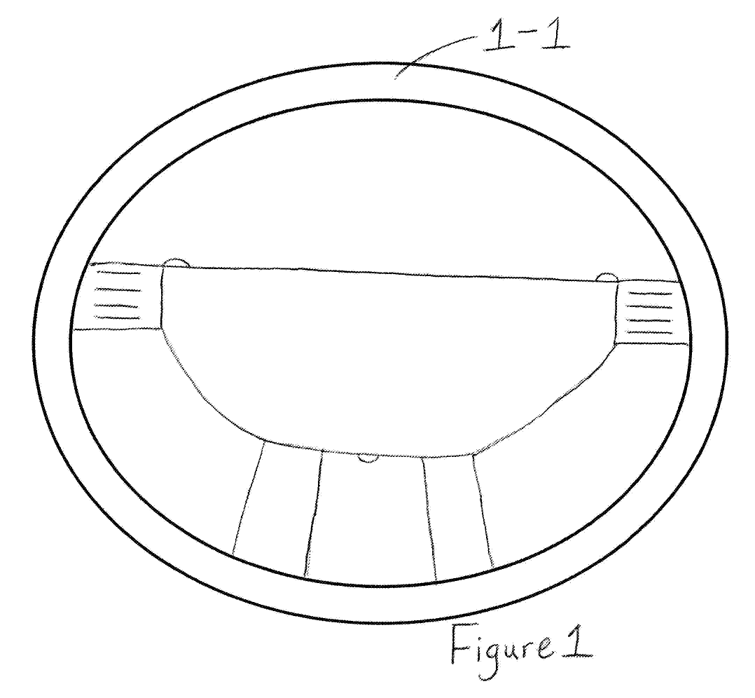

FIG. 2 This is a side view of the steering wheel.

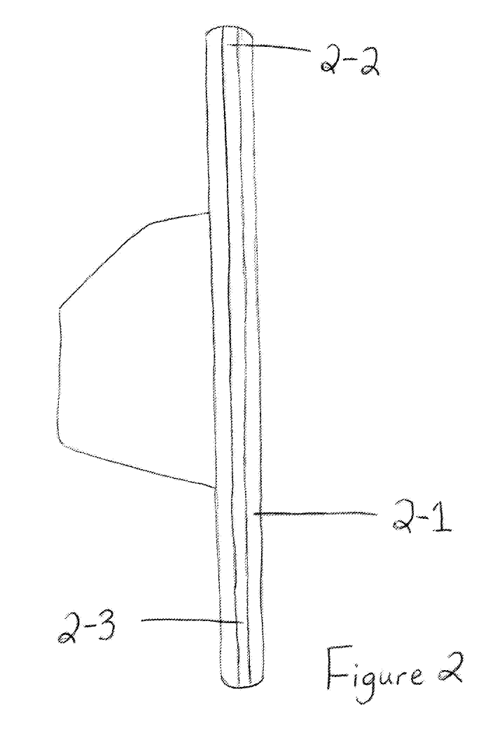

FIG. 3 This is a front view of the steering wheel with leather grip cover removed.

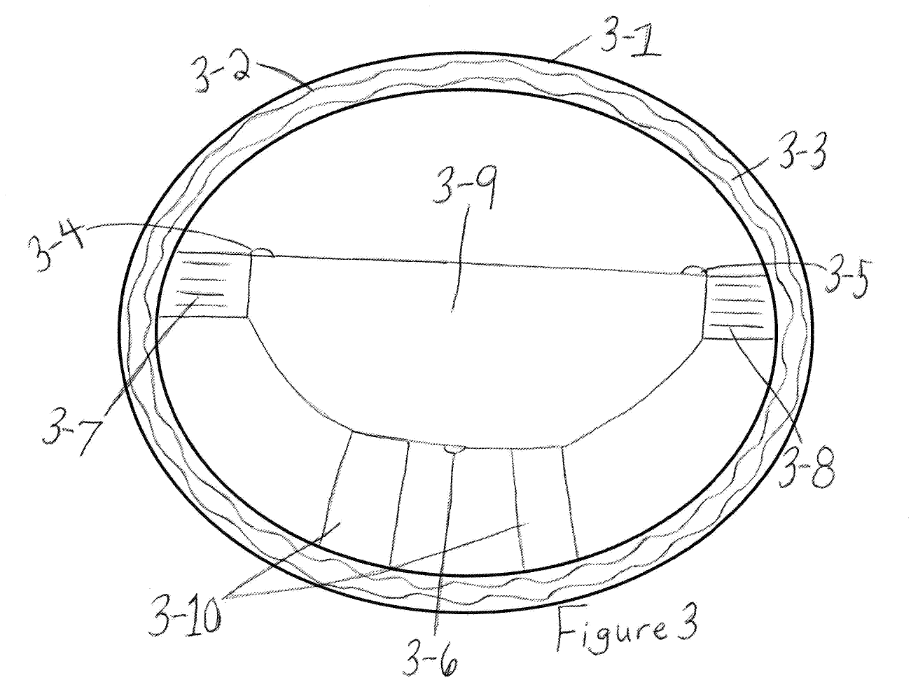

FIG. 4 This is a front view of the steering wheel with the airbag and port covers removed.

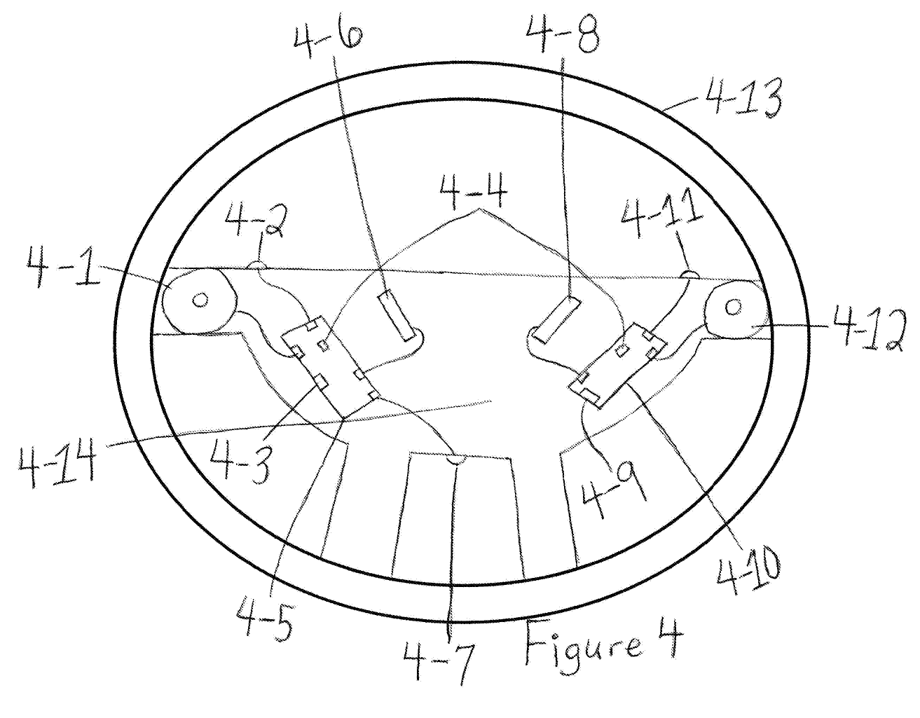

FIG. 5 This is a front view of a phone, app, and capabilities.

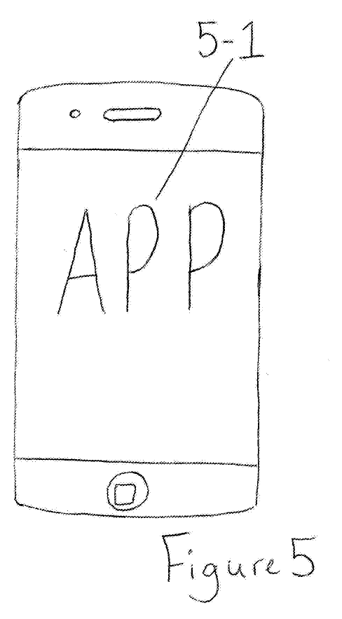

FIG. 6 This is a back view of the steering wheel with leather grip cover removed.

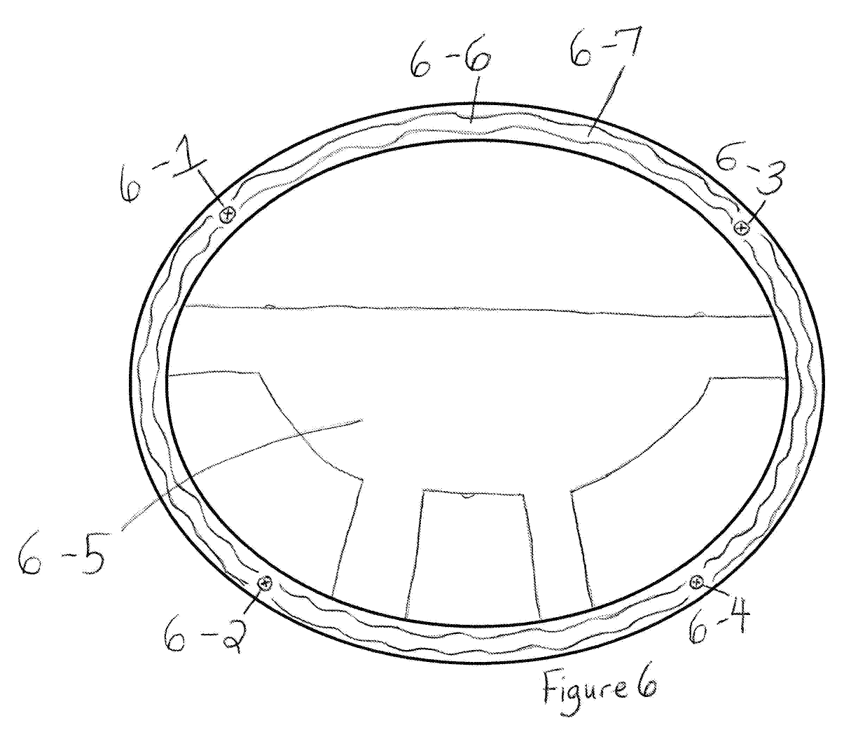

1. Design including a steering wheel and app working together to operate.

2. Design uses interruption feature in steering wheel preventing texting, facetime, social sites, and social media.

3. Design will disarm interruption feature when vehicle gear is placed in park.

4. Design has alcohol detector and heart rate sensor combined that protrudes from the outside of the steering wheel through the steering wheel to protrude out the inside of steering wheel ring.

5. Design will broadcast event in app if driver alcohol level is over legal limit.

6. Design will cause the steering wheel to lock if driver alcohol level is over legal limit.

7. Design will call and text contacts in app on behalf of driver if he or she is over legal alcohol level.

8. Design has gel pressure sensors under leather cover of steering wheel to detect pressure.

9. Design will alert driver if there is not enough pressure by sending sound through speakers in the steering wheel and flashing lights that are located on the steering wheel.

10. Design will call and text contacts in app on behalf of driver if there is not enough pressure on steering wheel.

11. Design will detect erratic speeds.

12. Design will call and text contacts in app on behalf of driver if erratic speeds are detected.

13. Design has Bluetooth inside steering wheel that connects steering wheel to phone.

14. Design has tracking device inside steering wheel that can be tracked through app.

15. Design creates a way to speak through speakers in steering wheel due to Bluetooth capabilities.
